(19) United States
(12) Patent Application Publication
(10) Pub. No.: US 2002/0068629 A1
(43) Pub. Date: Jun. 6, 2002

(54) Off-line gaming

(75) Inventors: David Howard Allen, Rochester, MN (US); Gregory John Uhlmann, Rochester, MN (US)

Correspondence Address: Gero G. McClellan, Thomason, Moser & Patterson, L.L.P., Suite 1500, 3040 Post Oak Boulevard, Houston, TX, 77056-6582, US

(73) Assignee: International Business Machines Corporation, Armonk, NY (US)

(21) Appl. No.: 09/727,887

(22) Filed: Dec. 1, 2000

(51) Int. Cl. G06F 19/00

(52) U.S. Cl. 463/42

(57) ABSTRACT

The present invention provides a method, apparatus and article of manufacture configured to allow off-line gaming. A client computer receives a gaming application and a token from a gaming provider server. The gaming application is configured to allow execution of one or more games on the client computer in the absence of a network connection with the gaming provider. The results of the games cause modification of the token. The token may then be redeemed for any residual value.

### BACKGROUND OF THE INVENTION

1. Field of the Invention

The present invention relates to the information processing field. More particularly, the invention relates to off-line gaming.

2. Background of the Related Art

With the explosion of the Internet, many conventional activities are now being provided in a networked forum. Online activities enjoy many advantages over conventional methods including lower overhead costs for service providers, anonymity for clients, remote accessibility and the like.

One online activity that is becoming increasingly popular is online gaming. Online gaming facilities are typically structured as web sites remotely accessible by virtual patrons operating client computers. The virtual patrons interact with the web sites according to the rules of the particular game being played and additional rules imposed by the web site host. In some cases, a user may play against a computer opponent while in other cases the opponents include other patrons networked with the web site.

A wide variety of games are currently available to users of the Internet. Of particular interest to some users are casino games including poker, blackjack, craps, baccarat, slot machines and the like. Such games involve placing bets or otherwise proffering a sum of money before the user is allowed to play. Accordingly, users are first required to provide the virtual casino with credit card information including the user name, the card type, the account number and the credit card expiration date. The user is then free to participate in the games provided by the virtual casino. Credits and debits are made against the user's account (typically a credit card account) according to whether the user wins or losses the hand/game. One problem with online gaming is that the user is required to maintain a network connection with the gaming host (the web site of the virtual casino) while the game is played. Such a system is highly restrictive on a user's ability to choose when and where to participate in virtual gambling.

Therefore, there is a need for a method, apparatus and article of manufacture to facilitate off-line virtual gambling.

### SUMMARY OF THE INVENTION

The present invention provides a method, apparatus and article of manufacture configured to allow virtual gambling without a network connection. One aspect of the invention provides a method for off-line gambling. The method comprises providing, via a network, a gaming token to a client computer during a first network connection. The gaming token comprises a gaming credit against which a user may place gambling bets while operating an authorized gaming application executing on the client computer in the absence of a network connection with the network. An initial gaming credit value is charged against a user account. During a second network connection, the gaming token is received from the client computer after having been modified by the client computer. A value of the gaming credit is then determined and, if the value of the gaming credit is positive, the user account is credited in an amount equal to the value of the gaming credit.

Another aspect of the invention provides a signal-bearing medium containing a executable information which, when executed by a computer in the absence of a network connection to a gaming provider, performs a method. The method comprises executing a game and, in response to an outcome of the game, modifying a value of a data structure provided by the gaming provider. The data structure is configured to be redeemed for monetary value during a network connection with the gaming provider.

Yet another aspect of the invention provides a networked system comprising a server connected to a network, wherein the server is configured to perform a method for off-line gaming. In one embodiment, the method comprises charging a user account in the amount of an initial gaming credit value and transmitting a gaming data structure to the client computer during a first network connection, wherein the data structure has an initial value equal to the initial gaming credit value and is configured to be modified by an authorized gaming application residing on the client computer. During a second network connection, the gaming data structure is received by the server after being modified by the client in the absence of a network connection with the server. A determination is then made as to whether the gaming data structure has a residual value and if so, the user account is credited in the amount of the residual value.

### BRIEF DESCRIPTION OF THE DRAWINGS

The teachings of the present invention can be readily understood by considering the following detailed description in conjunction with the accompanying drawings, in which:

FIG. 1 depicts a simplified block diagram of a networked system.

FIG. 2 depicts a simplified block diagram of a client computer connected to a network and a gaming provider server.

FIG. 3 depicts a data structure containing token information.

FIG. 4 depicts a flow diagram illustrating a method by which a client receives a token and a gaming application.

FIG. 5 depicts a flow diagram illustrating a method by which a client executes a gaming application causing modification to a token.

FIG. 6 depicts a flow diagram illustrating a method by which a client redeems a token.

To facilitate understanding, identical reference numerals have been used, where possible, to designate identical elements that are common to the figures.

### DETAILED DESCRIPTION OF THE PREFERRED EMBODIMENT

The present invention provides a method, apparatus and article of manufacture configured to allow off-line gaming. The invention has particular application to wide area networks (WANs), such as the Internet. However, the invention contemplates embodiments in any network environment including local area networks (LANs). Further, although embodiments of the invention are described with particular reference to gambling, the invention has application to any gaming applications in which user credits (e.g., monetary credits, hit points or number of “lives” (as in a role playing game), etc.) must be accounted for during offline play.

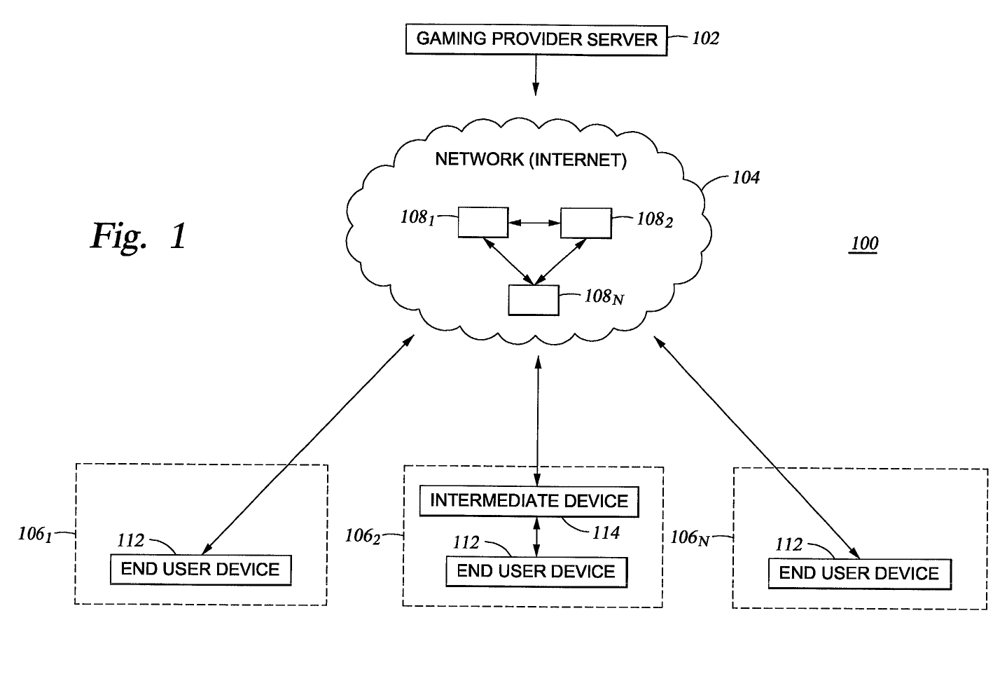

FIG. 1 depicts a networked system 100. The system 100 generally represents any networked system. The system 100 comprises a gaming provider server 102, a network 104 and a plurality of client computers 106₁, 106₂, . . . 106ₙ. The network 104 may be any system for connecting the client computers 106 and the server 102 and allowing information exchange therebetween. Illustratively, the network 104 is the Internet and comprises a plurality of network servers 108 (including, for example, hyper text transfer protocol (http) servers, domain name servers (DNS) and the like). The servers 102, 108 may be accessed according to unique network addresses. One addressing format that may be used to advantage is the Uniform Resource Locator (URL) format, as is known in the art.

The gaming provider server 102 is a computer or system of computers configured to respond to requests submitted by the client computers 106 regarding off-line gaming. More specifically, the gaming provider server 102 contains the necessary hardware and software to handle communications with multiple clients, validate client accounts, manage client accounts, generate and authenticate gaming information, etc.

The client computers 106 are connected to the gaming provider server 102 through the network 104. Connection between the client computers 106 and the network 104 may be facilitated by any variety of methods and devices including the use of telephone modems, cable modems, ISDN lines and the like. Communications can be supported by any known or unknown protocols. One popular protocol which can be used to advantage is TCP/IP.

As used herein “client computer” refers to any computer system or device(s) which is configured to receive gaming information from the provider server 102. Each client computer 106 may be a computer system, a network appliance, a wireless device and the like. In a particular embodiment (shown in FIG. 1), the client computer 106 is an end user device 112 on which a user executes gambling applications and enjoys off-line gaming. In particular, the end user device 112 may be a portable device including hand-held devices (e.g., palm-pilots) and laptops. Further, the end user device 112 may be a general-purpose computer configured to perform the functions described herein as well as other common data processing functions, or may be a specific-purpose device capable only of the gaming functions described herein.

In one embodiment, represented in FIG. 1 by client computer 1061, the end user device 112 interfaces directly with the gaming provider server 102. In another embodiment, as represented in FIG. 1 by client computer 106₂, the client computer 106 includes the end user device 112 and one or more intermediate devices 114. In this case, the intermediate device 114 provides an interface between the gaming provider server 102 and the end user device 112. Illustratively, the intermediate device is a desktop PC connected to the end user device 112 by a serial or parallel interface.

Periodically, the network connection between the client computers 106 and the gaming provider server 102 is terminated such that the client computer 106 is considered to be “off-line.” For purposes of the present description, the client computer 106 is considered to be “off-line” in the absence of a network connection (either direct or indirect) between the end user device 112 and the gaming provider server 102. In the event that the client computer 106 includes an intermediate device 114 currently connected with the gaming provider server 102, the client computer 106 is considered to be “off-line” when the end user device 112 is not in communication with (e.g., detached from) the intermediate device 114. If, however, the intermediate device 114 is not connected to the gaming provider server 102, then the end user device 112 and the intermediate device 114 may remain connected to one another and the client computer 106 is still considered to be off-line. In the latter situation, the client computer 106 may still be connected to the network 104. However, in a more particular embodiment, the client computer 106 is off-line in the absence of a connection with the network 104. During the time the end user device 112 is off-line (i.e., disconnected from the gaming provider server 102) or completely disconnected from the network 104 the user may enjoy gambling by executing gaming applications residing on the end user device 112.

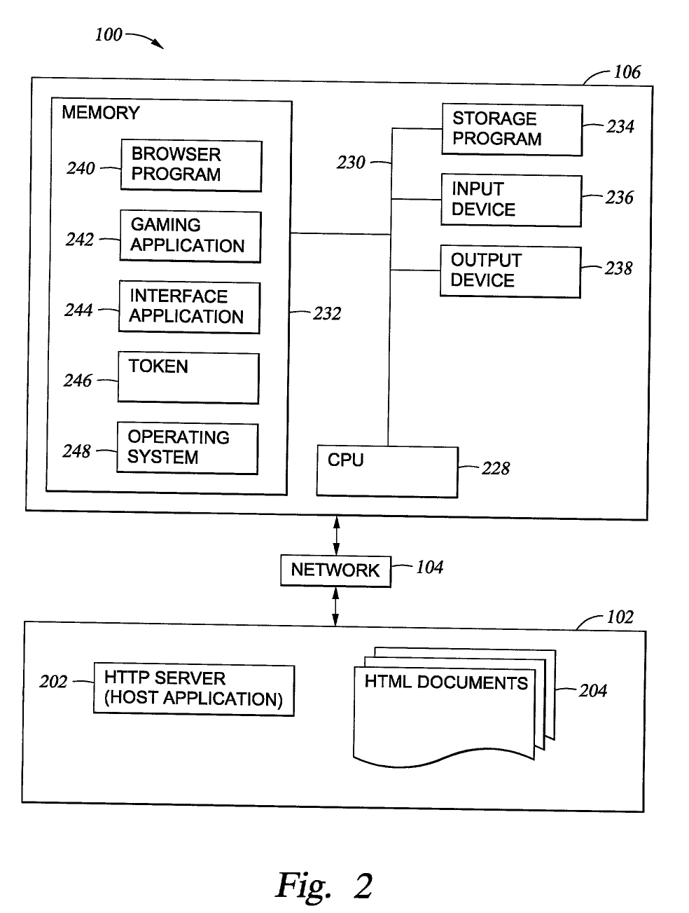

FIG. 2 shows a high-level diagram of one embodiment of the system 100. Illustratively, the gaming provider server 102 is a web-based server executing a hypertext transfer protocol (http) sever 202. The http server 202 is adapted to service requests from the client computer 104 regarding Hypertext Markup Language (HTML) documents 204 residing on the server 102. The precise location of HTML documents 204 on the server 102 are specified by network information addresses (e.g., URLs). Although shown as a http server, the gaming provider server 102 can be any device or process configured to respond to requests from client computers regarding off-line gambling.

In general, each client computer 106 includes a Central Processing Unit (CPU) 228 connected via a bus 230 to a memory 232, storage 234, input device 236, and output device 238. The input device 236 can be any device to give input to the client computer 106. For example, a keyboard, keypad, light-pen, touch-screen, track-ball or speech recognition unit could be used. The output device 238 is preferably any conventional display screen and, although shown separately from the input device 236, the output device 238 and input device 236 could be combined. For example, a display screen with an integrated touch-screen, and a display with an integrated keyboard or a speech recognition unit combined with a text speech converter could be used.

Storage 234 is may be a Direct Access Storage Device (DASD), although it is shown as a single unit, it could be a combination of fixed and/or removable storage devices, such as fixed disc drives, floppy disc drives, tape drives, removable memory cards, or optical storage. Memory 232 and storage 234 could be part of one virtual address space spanning multiple primary and secondary storage devices.

Memory 232 is preferably random access memory sufficiently large to hold the necessary programming/data structures. While memory 232 is shown as a single entity, it should be understood that memory 232 may in fact comprise a plurality of modules, and that memory 232 may exist at multiple levels, from high speed registers and caches to lower speed but larger DRAM chips.

Memory 232 is shown containing a browser program 240, a gaming application 242, an interfacing application 244, a token 246 and an operating system (O/S) 248. When executed on CPU 228, the browser program 240 provides support for navigating between the various network servers 108 (shown in FIG. 1) and the gaming provider server 102. Accordingly, the browser program 240 is configured to locate information (e.g., web pages) at one or more of the servers 102, 108. Although only one browser is shown residing on each client computer 106, the invention contemplates computers comprising any number of browsers, which may be other same or varying types. One browser which may be configured to support the present invention is Netscape Navigator®, provided by Netscape Communications of Mountain View, Calif.

In general, the interfacing application 244 supports communications between the client computer 106 and the gaming provider sever 102. In addition, the interfacing application 244 is configured to generate a gaming application signature as will be described in more detail below. Although shown residing in memory 232, interfacing application 244 may be any combination of software and hardware which supports interfacing the client and the gaming provider server 102. In addition, the interfacing application 244 may be an integral component of the browser program 240 or may be a separate entity, such as a plug-in. In the case where the client computer 106 comprises an end user device 112 and an intermediate device 114, the interfacing application 244 is located on the intermediate device 114. In the absence of an intermediate device 114, the interfacing application 244 resides on the end user device 112.

The token 246 is a data structure containing gaming information, some of which is modified during execution of the gaming application 242. Although the token 246 is shown residing in memory 232, the initial contents of the token are provided by the gaming provider server 102.

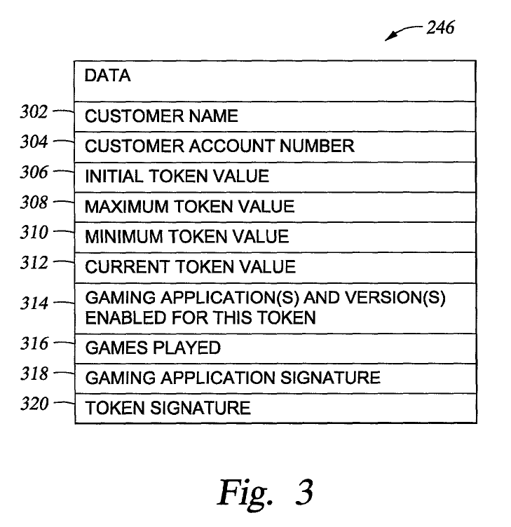

One embodiment of the token 246 is shown in FIG. 3. The token 246 comprises various fields containing gaining gaming information. A first field 302 contains a client name. A second field 304 contains a client account number. The client account number indicates an account to be charged some amount of money authorized by the client for purposes of gambling. A third field 306 contains the initial value of the token, that is, the value of the token 246 upon its creation (which may be equal to the amount charged to the client account, less some transaction fees perhaps). A fourth field 308 and a fifth field 310 contain a maximum token value and a minimum token value, respectively. A sixth field 312 contains the current value of the token 246. Initially, the current value of the token 246 is equal to the initial token value contained in the third field 306. During the use of the token 246 (i.e., while the client is gambling) the value of the token 246 may fluctuate as the client wins and losses money. Accordingly, the value of the token 246 at any given time is recorded in the sixth field 312. A seventh field 314 contains information regarding the gaming applications and versions enabled for the particular token 246. Thus, the token 246 may only be used by a client to participate in those games indicated by the information contained in a seventh field 314. The number of games played by a client using a particular token 246 is indicated by information contained in an eighth field 316. A ninth field 318 and a tenth field 320 contain security information to ensure the proper use of the token 246. In particular, the ninth field 318 contains a gaming application signature and a tenth field 320 contains a token signature. The gaming application signature is generated by the client computer 106 on which the token 246 is used while the token signature (i.e., encryption information) is generated by the gaming provider server 102.

As will be described in detail below, one embodiment of the invention is implemented as a program product for use with a computer system such as, for example, the system 100 shown in FIG. 1. The program(s) of the program product defines functions of the embodiments and can be contained on a variety of signal/bearing media, which include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

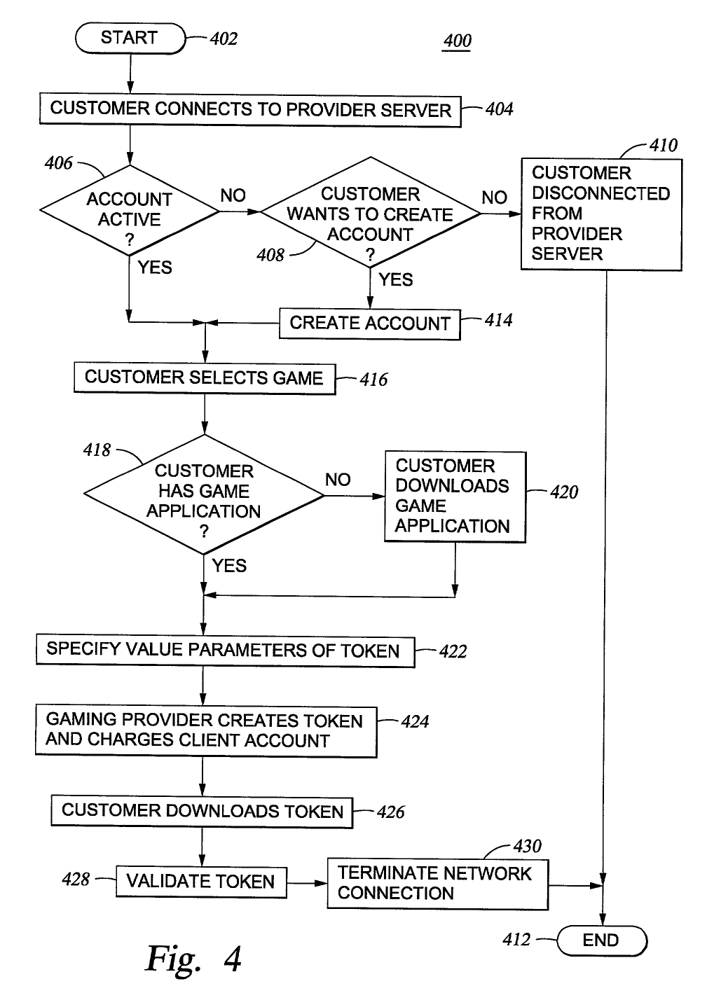

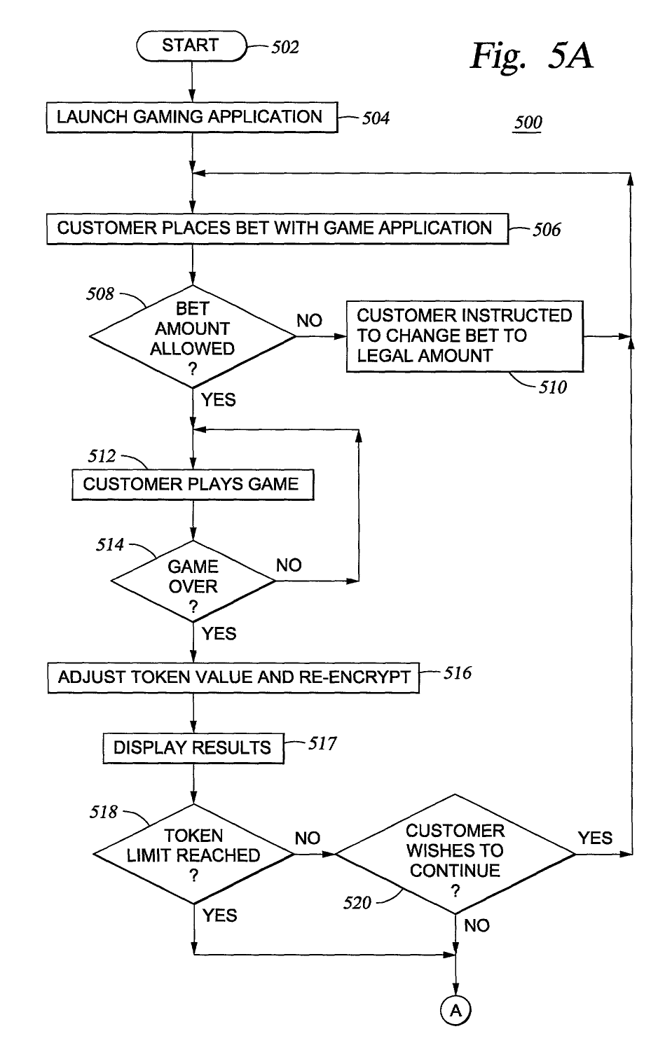

FIG. 4 shows a method 400 for operating the system 100. Method 400 is entered at step 402 and proceeds to step 404 where a user/client establishes a network connection between a client computer 106 and the gaming provider server 102. For example, while connected to the network 104, the client may provide the network address of the gaming provider server 102 to the browser program 240 residing on the client computer 106. The browser program 240 then takes steps known in the art to access the gaming provider server 102. At step 406, the method 400 queries whether an account for the client is active on the gaming provider server 102. This determination may be facilitated by submission of a user ID and password from the client computer 106 to the gaming provider server 102. If no account exists for the client, the method 400 queries whether the client would like to create an account at step 408. If the client responds in the negative, the network connection between the client computer 106 and the gaming provider server 102 is terminated at step 410. The method 400 then ends at step 412.

If, at step 408, the client answers affirmatively, the method proceeds to step 414 where an account is created for the client on the gaming provider server 102. Illustratively, creation of an account requires the client to provide a client name, address, Social Security number and a credit card account number.

Method 400 then proceeds to step 416 where the client selects one or more games to be downloaded from the gaming provider server 102 and played off-line. Preferably, the selection is made from a list of games provided to the client computer 106 by the gaming provider server 102. illustrative games included poker, blackjack, roulette and other popular casino games.

In some cases, a returning customer with an active account may have previously downloaded the games selected at step 416. Accordingly, method 400 queries (at step 418) whether the appropriate versions of the selected games already reside on the client computer 106. If not, method 400 proceeds to step 420 where the selected games (i.e., the gaming applications 242) are downloaded from the gaming provider server 102 to the client computer 106. In some embodiments, the host of the gaming provider server 102 (i.e., the gaming provider) may require clients to download the gaming applications 242 periodically, or even at every connection, regardless of whether a copy of the gaming applications 242 resides on the client computer 106. Such a requirement may be desirable in order to allow the gaming provider to periodically vary encryption information used to mitigate the potential for tampering with the gaming application code, or otherwise attempting to defraud the gaming provider.

If an appropriate copy of the gaming applications exists on the client computer 106, or after the appropriate copy has been downloaded, the method 400 proceeds to step 422. At step 422, value parameters of the token 246 are specified. At a minimum, an initial value of the token 246 is provided and stored to the third field 306. In addition, a maximum token value (contained in the fourth field 308) and a minimum token value (contained in the fifth field 310) are provided. The maximum and minimum values are limits which restrict the client's use of the token 246 to a range of values within the limits. Accordingly, the current token value (contained in the sixth field 312) must always be a value between the maximum and minimum values. Preferably, the maximum and minimum values are specified by the gaming provider server 102 because the values facilitate security measures used by the gaming provider server 102 to prevent misuse of the token 246. However, in some embodiments, the client may be allowed some degree of flexibility in determining the values. For example, the client may be provided with a list containing a range of max/min values from which to select.

Method 400 then proceeds to step 424 where the gaming provider server 102 creates a token 246 according to the information submitted by the client computer 102 as well as additional information such as the gaming application information contained in the seventh field 314 of the token 246. The token 246 is encrypted (the encryption information is contained in the tenth field 320 of the token 246 shown in FIG. 3) to prevent unauthorized modification of the token's contents. Specifically, the encryption information may allow only authenticated/certified copies of the gaming applications 242 to make modifications to the information contained in the token. In addition, at step 424, the gaming provider server 102 takes steps to transfer funds from the account specified by the client and for the amount authorized by the client.

Subsequently, at step 426, the token 246 generated by the gaming provider server 102 is downloaded by the client computer 106. At step 428 the token 246 is validated by the client computer 106. Validation ensures that the transmission of the token 246 and other pertinent data was successful. Illustratively, validation occurs when the token 246 is recognized by the gaming application 242 residing on the client computer 106. In one embodiment, validation includes accessing the information contained in the seventh field 314 of the token 246.

The network connection between the client computer 106 and the gaming provider server 102 (and possibly the network 104) is then terminated at step 430. The method 400 ends at step 412.

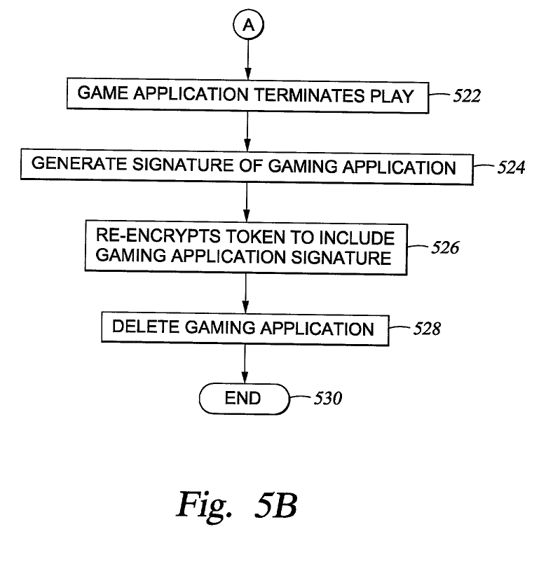

FIG. 5 shows a method 500 illustrating events during a gaming session while the client computer 106 is off-line. The method 500 is entered at step 502 and proceeds to step 504 where the gaming application 242 is launched (e.g., in response to a user issue command). Step 504 may also include selection by the client of a particular game from a suite of games made available by the gaming application 242. At step 506 the client places a bet according to the rules of the particular game being played. At step 508, the gaming application 242 determines whether the bet is allowed. For example, a bet is not allowed which, if lost, would reduce the current token value to less than the minimum token value limit (or less than zero if no minimum token value has been set) or, if won, would increase the current token value to greater than the maximum token value limit. If the bet placed by the client is not allowed, the client is prompted by the gaming application 242 to change the bet to a legal amount. For convenience, the gaming application 242 may display to the client the betting limitations as defined by the token 246. The method 500 then returns to step 506 and step 508. Once a determination is made at step 508 that the amount bet by the client is permissible, the method 500 proceeds to step 512 where the game is played.

It should be noted that while embodiments discussed herein utilize max/min values, other embodiments do not. In particular, some games may not be conducive to max/min values. In general, such games include those for which the payout cannot be predetermined. For example, the payout of slot machines cannot be predetermined, i.e., the results of the cannot be known prior to pulling the virtual lever. Therefore, it is not feasible to impose a maximum value limitation on the token 246.

At step 514 the method 500 queries whether the game is over. A game is over at the occurrence of any event which requires an adjustment to the value of the token 246. For example, a game of blackjack may be over each time the client wins or loses a hand. If the game is not over, the method 500 returns to step 512 and the client continues planning the game. When a determination is made at step 514 that the game is over, the method 500 proceeds to step 516 at which time the value of the token 246 is adjusted according to the outcome of the game. The token 246 is then re-encrypted by the gaming application 242.

The outcome of the game, including the amount of any losses or wins on the part of the client, is displayed on the output device 238 of the client computer 106. Accordingly, the modification of the token 246 at step 516 occurs prior to displaying the outcome of the game. This sequence of events prevents a client from interfering with the recording of an unfavorable outcome (e.g., by terminating the supply of power to the client computer 106).

At step 518, the method 500 queries whether a token limit (as defined by the information contained in the fourth and fifth fields 308, 310 of the token 246 shown in FIG. 3) has been reached. If the query is answered negatively, the method 500 proceeds to step 520 and queries whether the client wishes to continue gaming. If so, the method 500 returns to step 506. If a token limit has been reached at step 518 or if the client does not wish to continue at step 520, the method 500 proceeds to step 522 where the gaming application 242 terminates play.

At step 524, the gaming application 242 generates a gaming application signature. Illustratively, the gaming application signature is a checksum or other comparable scheme. At step 526, the interface application 244 then re-encrypts the token 246 to include the gaming application signature. The method 500 then proceeds to step 528 where the interface application 244 deletes the gaming application 242 from the client computer 106. The method 500 then ends at step 530.

It should be understood that in some cases the token 246 has a current value within any specified max/min values such that the user may utilize the token at a future time for additional gaming. In such cases, step 528 may be avoided to allow the user to resume gaming at a future time. Avoiding step 528 may be accomplished by providing the user with an option to resume gaming at a future time or cashing out. If the user elects to resume future gaming, the gaming application 242 is not deleted at step 528. If the user elects to cash out, the gaming application 242 is deleted at step 528. In other embodiments, the gaming application 242 is deleted regardless of the value of the token 246 once a user elects to terminate a gaming session. Such an approach may be a desirable security feature preventing the user from tampering with the token 246 (e.g., after losing money), since the gaming application 242 is needed to generate the gaming application signature.

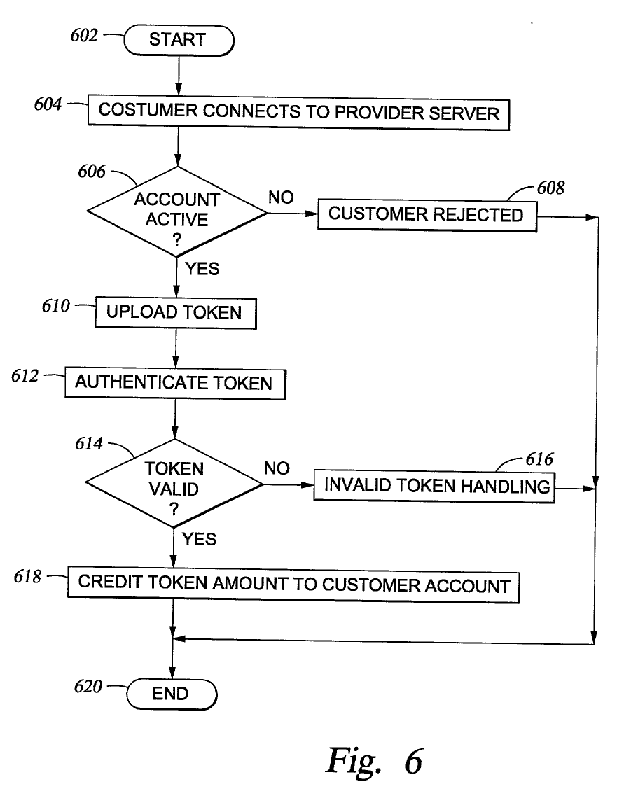

FIG. 6 shows a method 600 by which the client may redeem a token 246 for any residual value. The method 600 begins at step 602 and proceeds to step 604 where the client computer 106 establishes and network connection with the gaming provider server 102. The network connection may be established by submission of a valid password and user ID from the client computer 106.

At step 606, the gaming provider server 102 queries whether an account exists for the information provided by the client. If no account is found matching the client-provided information, the client is denied access to the gaming provider server 102 at step 608 and the method 600 ends at step 620. Additionally or alternatively, the gaming provider server 102 may provide the client with an opportunity to create a new account in a manner according to the steps described above with reference to FIG. 4 (see steps 408 and 414). However, in the event that a new account is created, the client will not be able to redeem existing tokens.

If a determination is made at step 606 that an active account exists for the client, the method 600 proceeds to step 610 where the client uploads the token 246 to the gaming provider server 102. The gaming provider server 102 then takes steps to determine the authentication of the token 246 at step 612. Illustratively, the authentication determines whether the token has been corrupted either accidentally (for example by a communications error) or was intentionally manipulated (e.g., in an attempt to defraud the gaming provider server 102). The authentication may include a comparison of the current token value to an allowed maximum token value, verification of the gaming application signature (to determine that the token was modified by a certified gaming application 242), etc. In one embodiment, the authentication includes a time/date check to determine whether the token has expired as a result of the client's failure to reconnect to the gaming provider server 102 within a predetermined time periods (for example, 90 days).

If the token 246 cannot be authenticated, the method 600 proceeds to step 616 where the token is flagged for handling by the gaming provider server 102 according to predetermined handling procedures. Illustratively, predetermined handling procedures include notifying the appropriate authorities to investigate the user and locking up the user's account to prevent future gaming until the issue is resolved. The method 600 then ends at step 620. If the token 246 is authenticated, the method 600 proceeds to step 618 where the gaming provider server 102 credits the residual token value (contained in the sixth field 312 of the token 246 shown in FIG. 3) to the customer account (as specified by the information contained in the second field 304 of the token 246 shown in FIG. 3). The method 600 then ends at step 620.

While the foregoing is directed to the specific embodiments of the present invention, other and further embodiments of the invention may be devised without departing from the basic scope thereof, and the scope thereof is determined by the claims that follow.

What is claimed is:

1. A method for off-line gambling, comprising:
providing, via a network, a gaming token to a client computer during a first network connection, wherein the gaming token comprises a gaming credit against which a user may place gambling bets while operating an authorized gaming application executing on the client computer in the absence of a network connection with the network;
charging a user account in the amount of an initial gaming credit value;
receiving, via the network, the gaming token from the client computer during a second network connection, wherein the gaming token has been modified by the client computer;
determining a value of the gaming credit; and
if the value of the gaming credit is positive, crediting the user account in an amount equal to the value of the gaming credit.

2. The method of claim 1, wherein the gaming credit is configured to be adjusted periodically during execution of the authorized gaming application.

3. The method of claim 1, wherein the initial gaming credit value is determined in response to a request from the client computer indicating a monetary value to be charged against the user account.

4. The method of claim 1, wherein client computer is one of a handheld computer, a laptop computer and a desktop.

5. The method of claim 1, providing, via the network, the authorized gaming application to the client computer during the first network connection.

6. The method of claim 1, wherein the gaming token contains gaming application information utilized to verify the authorized gaming application which, when executed on the client computer, is configured to cause adjustments to be made to a value of the gaming credit.

7. The method of claim 1, wherein the first and second network connections are Internet connections.

8. The method of claim 1, wherein the authorized gaming application is configured for at least one gambling game.

9. The method of claim 1, wherein the gaming credit comprises a minimum value, and wherein the authorized gaming application is configured to prevent placing a bet when the value of the gaming credit will be reduced to a value equal to or less than the minimum value as a result of losing the bet.

10. The method of claim 1, wherein the gaming credit comprises a minimum value and maximum value, and wherein the authorized gaming application is configured to prevent placing a bet when the value of the gaming credit will be reduced to a value equal to or less than the minimum value as a result of losing the bet and increased to a value equal to or greater than the maximum value as a result of winning the bet.

11. The method of claim 1, further comprising providing, via the network, the authorized gaming application to the client computer.

12. The method of claim 1, further comprising encrypting the gaming token prior to providing the gaming token to the client computer.

13. The method of claim 1, further comprising authenticating the gaming token prior to crediting the user account.

14. The method of claim 13, wherein authenticating the gaming token comprises processing a gaming signature contained in the gaming token and generated while the token is residing on the gaming provider server.

15. A signal-bearing medium containing a executable information which, when executed by a computer in the absence of a network connection to a gaming provider, performs a method, comprising:
executing a game; and
modifying, in response to an outcome of the game, a value of a data structure provided by the gaming provider, wherein the data structure is configured to be redeemed for monetary value during a network connection with the gaming provider.

16. The signal-bearing medium of claim 15, wherein the game is a casino game.

17. The signal-bearing medium of claim 15, further comprising generating a gaming signature configured to be used by the gaming provider to authenticate the data structure upon redeeming the data structure.

18. The signal-bearing medium of claim 15, wherein the data structure contains a maximum value and a minimum value and wherein the executable instructions are configured to prevent execution of the game when a current value of the data structure will be reduced to a value equal to or less than the minimum value as a result of losing the game and increased to a value equal to or greater than the maximum value as a result of winning the game.

19. The signal-bearing medium of claim 15, further comprising encrypting the data structure after modifying the value of the data structure.

20. The signal-bearing medium of claim 19, displaying the outcome of the game after encrypting the data structure.

21. The signal-bearing medium of claim 15, prior to executing the game, parsing input from a user to determine whether conditions for execution of the game are satisfied and proceeding to the executing step only if the conditions for execution are satisfied.

22. The signal-bearing medium of claim 21, wherein the conditions for execution of the game are satisfied when, after adjusting a current value of the data structure for an outcome of the game, the current value will be equal to or greater than a minimum value and less than or equal to a maximum value.

23. A networked system comprising a server connected to a network, wherein the server is configured to perform a method, comprising:
charging a user account in the amount of an initial gaming credit value;
transmitting a gaming data structure to the client computer during a first network connection, wherein the data structure has an initial value equal to the initial gaming credit value and is configured to be modified by an authorized gaming application residing on the client computer;
receiving, during a second network connection, the gaming data structure after being modified by the client in the absence of a network connection with the server;
determining whether the gaming data structure has a residual value; and
if so, crediting the user account in the amount of the residual value.

24. The networked system of claim 23, wherein the gaming data structure contains gaming application information utilized to determine whether the authorized gaming application is permitted to modify the gaming data structure.

25. The networked system of claim 23, wherein the gaming data structure contains a maximum value and a minimum value and wherein the authorized gaming application is configured to prevent placing a bet when a current value of the gaming data structure will be reduced to a value equal to or less than the minimum value as a result of losing the bet and increased to a value equal to or greater than the maximum value as a result of winning the bet.

26. The networked system of claim 23, wherein the server is configured to authenticate the gaming data structure prior to crediting the client account.

27. The networked system of claim 23, wherein the server is configured to encrypt the gaming data structure prior to transmitting a gaming data structure to the client computer.

28. The networked system of claim 23, wherein the server is a Web server.

29. The networked system of claim 23, wherein the server is configured to transmit the authorized gaming application to the client computer.

30. The networked system of claim 23, wherein the authorized gaming application is configured for execution of at least one casino game.

31. The networked system of claim 23, wherein the authorized gaming application is configured to encrypt the gaming data structure while the gaming data structure resides on the client computer.

32. The networked system of claim 23, wherein the server is configured to establish a gaming account for a user of the client computer according to user-provided information.
